(19) United States
(12) Patent Application Publication
(10) Pub. No.: US 2009/0106273 A1
(43) Pub. Date: Apr. 23, 2009

(54) AUTONOMIC GENERATION OF PROFILES IN A CONTENT MANAGEMENT SYSTEM

(76) Inventor: John Edward Petri, Lewiston, MN (US)

Correspondence Address: MARTIN & ASSOCIATES, LLC, P.O. BOX 548, CARTHAGE, MO, 64836-0548, US

(21) Appl. No.: 11/876,421

(22) Filed: Oct. 22, 2007

(51) Int. Cl. G06F 17/30

(52) U.S. Cl. 707/100; 707/E17.001

(57) ABSTRACT

A content management system (CMS) includes an autonomic profile generation mechanism that autonomically generates one or more profiles based on one or more patterns detected in a schema for an object. Autonomically generating profiles allows documents to be rendered in more efficient ways, avoiding the rendering of content that is not needed according to the profiles. The autonomic generation of profiles may be performed at the request of a user, when a user creates a new schema, when a user modifies an existing schema, or at configured times.

### BACKGROUND

1. Technical Field

This disclosure generally relates to content management systems, and more specifically relates to profiling in a content management system.

2. Background Art

A content management system (CMS) allows many users to efficiently share electronic content such as text, audio files, video files, pictures, graphics, etc. Content management systems typically control access to content in a repository. A user may generate content, and when the content is checked into the repository, the content may be subsequently processed by the CMS according to predefined rules. A user may also check out content from the repository, or link to content in the repository while generating content. The rules in a CMS assure that content that comes into or out of the system or that is linked to meets desired criteria specified in the rules.

Profiling is an XML content management technique in which elements of an XML document may be tagged with applicability metadata. This applicability metadata can be used by the CMS to filter content and only allow certain elements to be included. Currently, a profile for a document allows the content management system to extract only that content from the document that matches the profile. For example, a document for an owner's manual may include instructions in English and Spanish. If a new document is created with a profile of English, only the elements that match the English profile will be included in the new document. Similarly, if a new document is created with a profile of Spanish, only the elements that match the Spanish profile will be included in the new document. Profiling thus allows a way to select and filter content when a document is reconstituted (i.e., assembled) according to one or more defined profiles for the document.

Method 200 in FIG. 2 is a prior art method for reconstituting a document that may include a defined profile. Method 200 begins when a document needs to be reconstituted (step 210). The next element is retrieved (step 220). If the element has applicability metadata (step 230=YES), the element is included in the reconstituted document only if the document's profile matches the applicability metadata (step 250). If the element does not have applicability metadata (step 230=NO), the element is included in the document (step 240). If there are more elements to process (step 260=YES), method 200 loops back to step 220 and continues until there are no more elements to process (step 260=NO).

A sample document 300 is shown in FIG. 3. We assume document 300 is being reconstituted from a document that includes a link to document N 320, which includes two separate elements that each has applicability metadata. Note the document profile 310 is English. When the content management system encounters document N to incorporate into the reconstituted document 300, the CMS sees that document N 320 includes applicability metadata. Because the profile of the document 300 being reconstituted is English, which matches the applicability metadata for the first element 330, the first element 330 is incorporated into document 300 as shown in FIG. 3. Because the English profile of the document being reconstituted does not match the Spanish applicability metadata for the second element 340, the second element 340 is not included in the reconstituted document 300. Note that profiling may also be used when common elements are mixed with specific elements that vary based on applicability metadata. For example, a document might include a shipping address that has a street address, city and state that are common for all destinations. However, the format and location of the postal code varies depending on whether the address is an address in the United States or an address in a foreign country. In this case, there would be a single instance of the common data, with multiple instances of the postal code tagged with appropriate applicability metadata. These very simplified examples show how profiling is used in the prior art to include or exclude parts of a document depending on the profile of the document being created and the applicability metadata in the shared documents.

In known content management systems, profiles are generated by humans, such as an administrator or by authors of content. In both cases, a human must manually generate a profile. This manual process is prone to human errors. Without a way to automate the process for generating profiles in a content management system, the process for generating profiles will continue to be manual and subject to human errors.

### BRIEF SUMMARY

A content management system (CMS) includes an autonomic profile generation mechanism that autonomically generates one or more profiles based on one or more patterns detected in a schema for an object. Autonomically generating profiles allows documents to be rendered in more efficient ways, avoiding the rendering of content that is not needed according to the profiles. The autonomic generation of profiles may be performed at the request of a user, when a user creates a new schema, when a user modifies an existing schema, or at configured times.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a networked computer system that includes a server computer system that has a content management system that includes an autonomic profile generation mechanism that autonomically generates one or more profiles based on analysis of one or more schemas in the content management system;

FIG. 2 is a flow diagram of a prior art method for using profiling when reconstituting a document;

FIG. 3 is a block diagram showing a document being reconstituted that includes a profile, and shared content that includes applicability metadata;

FIGS. 4 and 5 show different portions of a flow diagram of a method for autonomically generating a profile based on analyzing a schema in a content management system;

FIG. 6 is a sample XML document;

FIGS. 7 and 8 show a sample schema for the XML document in FIG. 6;

FIG. 9 shows a sample profile that is autonomically generated from analyzing the schema in FIGS. 7 and 8;

FIG. 10 shows the document 600 in FIG. 6 being rendered to a user after applying the profile shown in FIG. 9;

FIG. 11 shows an alternative implementation for the second half of the schema definition 700 shown in FIG. 7;

FIG. 12 shows a sample profile stub that is generated autonomically for the schema shown in FIGS. 7 and 11; and

FIG. 13 shows the sample profile stub in FIG. 12 after a system administrator manually adds the allowed values for the region attribute.

### DETAILED DESCRIPTION

Many known content management systems use extensible markup language (XML) due to its flexibility and power in managing diverse and different types of content. One known content management system that uses XML is Solution for Compliance in a Regulated Environment (SCORE) developed by IBM Corporation. XML is growing in popularity, and is quickly becoming the preferred format for authoring and publishing. While the disclosure herein discusses XML documents as one possible example of content that may be managed by a content management system, the disclosure and claims herein expressly extend to content management systems that do not use XML.

An improved content management system is disclosed herein that autonomically generates a profile by analyzing a schema for one or more defined patterns, and when a defined pattern is found, a corresponding profile is autonomically generated that causes less than all elements defined in the selected schema to be rendered when a document corresponding to the selected schema is rendered to a user of the content management system. A schema may be analyzed as a result of a user creating the schema or modifying the schema. In the alternative, a periodic analysis of all schemas in the content management system could be scheduled. The autonomically generated profile may be a complete profile that is ready for use by the content management system, or may be a partial profile that requires additional input from a human user, such as an administrator. Once the profile is ready for use, a document that is an instance of the schema corresponding to the profile is rendered using the profile.

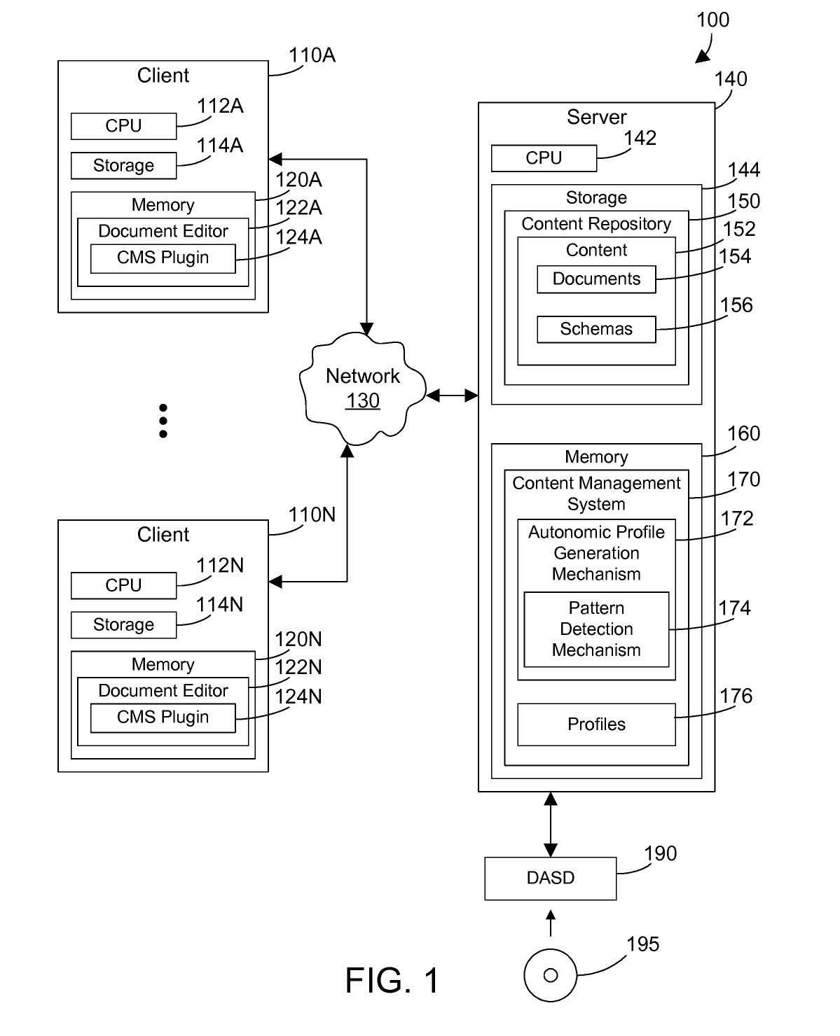

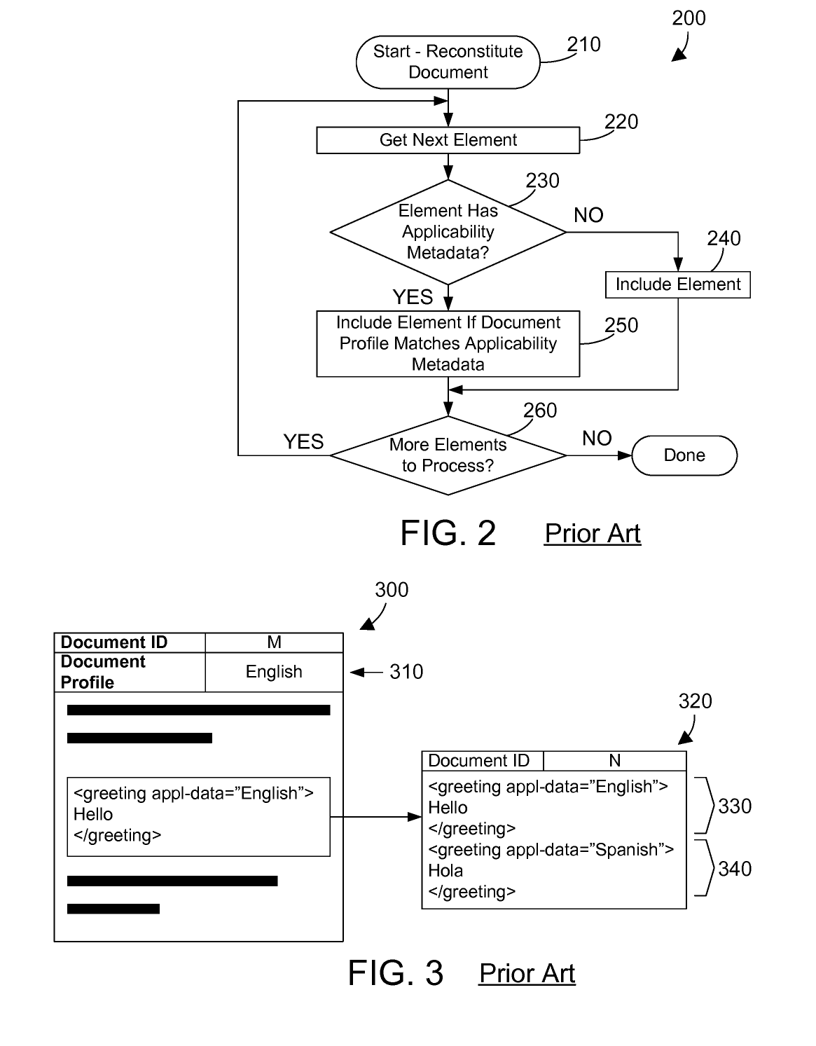

Referring to FIG. 1, networked computer system 100 includes multiple clients, shown in FIG. 1 as clients 110A, . . . , 110N, coupled to a network 130. Each client preferably includes a CPU, storage, and memory that contains a document editor, and a content management system (CMS) plugin. Thus, client 110A includes a CPU 112A, storage 114A, memory 120A, a document editor 122A in the memory 120A that is executed by the CPU 112A, and a CMS plugin 124A that allows the document editor 122A to interact with content 152 in the repository 150 that is managed by the CMS 170 in server 140. In similar fashion, other clients have similar components shown in client 110A, through client 110N, which includes a CPU 112N, storage 114N, memory 120N, a document editor 122N, and a CMS plugin 124N.

The CMS 170 resides in the main memory 160 of a server computer system 140 that also includes a CPU 142 and storage 144 that includes a content repository 150 that holds content 152 managed by the CMS 170. Content 152 may include one or more documents 154 and one or more schemas 156. In the most preferred implementations, schemas 156 define structure for documents 154, and documents 154 are preferably instances of a corresponding schema 156. As used in the disclosure and claims herein, the term “document” means any type of data that may be managed by a content management system, including all known types of data and objects as well as those developed in the future, and the term “element” means any section or portion of a document. In addition, the term “schema” means any suitable way to define a document, including without limitation document type definitions (DTDs), W3C XML Schemas, and any other known form of document definition, whether currently known or developed in the future.

One example of a suitable server computer system 140 is an IBM eServer System i computer system. However, those skilled in the art will appreciate that the disclosure herein applies equally to any type of client or server computer systems, regardless of whether each computer system is a complicated multi-user computing apparatus, a single user workstation, or an embedded control system. CMS 170 includes an autonomic profile generation mechanism 172 and profiles 176. Autonomic profile generation mechanism 172 includes a pattern detection mechanism 174 that analyzes a schema to determine whether one or more predefined patterns exist in the schema. One suitable example of a predefined pattern that pattern detection mechanism 174 could look for is an element that may occur multiple times in a schema, where the element includes an attribute that has a plurality of values. Profiles 176 are profiles that may be applied to documents 154 in the repository 150. In the most preferred implementation, a profile 176 corresponds to a specific schema 156. Note, however, that a profile may also be scoped to apply to multiple schemas or to any schema that satisfies specified criteria. When a profile applies to a schema, a document that is of the type defined by the schema will be rendered using the profile to render less than all elements in the document to the user according to the profile.

While the autonomic profile generation mechanism 172 is shown in FIG. 1 as part of content management system 170 on server computer system 140, one skilled in the art will appreciate that one or more of the features of the autonomic profile generation mechanism 172 could be implemented within a CMS plugin within a document editor on a client computer system, such as within CMS plugin 124A shown in FIG. 1. The disclosure and claims herein expressly extend to any suitable way to allocate different functions between a client and the server that hosts the content management system to achieve an autonomic profile generation mechanism as described herein.

In FIG. 1, repository 150 is shown separate from content management system 170. In the alternative, repository 150 could be within the content management system 170. Regardless of the location of the repository 150, the content management system 170 controls access to content 152 in the repository 150.

Server computer system 140 may include other features of computer systems that are not shown in FIG. 1 but are well-known in the art. For example, server computer system 140 preferably includes a display interface, a network interface, and a mass storage interface to an external direct access storage device (DASD) 190. The display interface is used to directly connect one or more displays to server computer system 140. These displays, which may be non-intelligent (i.e., dumb) terminals or fully programmable workstations, are used to provide system administrators and users the ability to communicate with server computer system 140. Note, however, that while a display interface is provided to support communication with one or more displays, server computer system 140 does not necessarily require a display, because all needed interaction with users and other processes may occur via the network interface.

The network interface is used to connect the server computer system 140 to multiple other computer systems (e.g., 110A, . . . , 110N) via a network, such as network 130. The network interface and network 130 broadly represent any suitable way to interconnect electronic devices, regardless of whether the network 130 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

The mass storage interface is used to connect mass storage devices, such as a direct access storage device 190, to server computer system 140. One specific type of direct access storage device 190 is a readable and writable CD-RW drive, which may store data to and read data from a CD-RW 195.

Main memory 160 preferably contains data and an operating system that are not shown in FIG. 1. A suitable operating system is a multitasking operating system known in the industry as i5/OS; however, those skilled in the art will appreciate that the spirit and scope of this disclosure is not limited to any one operating system. In addition, server computer system 140 utilizes well known virtual addressing mechanisms that allow the programs of server computer system 140 to behave as if they only have access to a large, single storage entity instead of access to multiple, smaller storage entities such as main memory 160, storage 144 and DASD device 190. Therefore, while data, the operating system, and content management system 170 may reside in main memory 160, those skilled in the art will recognize that these items are not necessarily all completely contained in main memory 160 at the same time. It should also be noted that the term “memory” is used herein generically to refer to the entire virtual memory of server computer system 140, and may include the virtual memory of other computer systems coupled to computer system 140.

CPU 142 may be constructed from one or more microprocessors and/or integrated circuits. CPU 142 executes program instructions stored in main memory 160. Main memory 160 stores programs and data that CPU 142 may access. When computer system 140 starts up, CPU 142 initially executes the program instructions that make up the operating system.

Although server computer system 140 is shown to contain only a single CPU, those skilled in the art will appreciate that a content management system 170 may be practiced using a computer system that has multiple CPUs. In addition, the interfaces that are included in server computer system 140 (e.g., display interface, network interface, and DASD interface) preferably each include separate, fully programmed microprocessors that are used to off-load compute-intensive processing from CPU 142. However, those skilled in the art will appreciate that these functions may be performed using I/O adapters as well.

At this point, it is important to note that while the description above is in the context of a fully functional computer system, those skilled in the art will appreciate that the content management system 170 may be distributed as an article of manufacture in a variety of forms, and the claims extend to all suitable types of computer-readable media used to actually carry out the distribution, including recordable media such as floppy disks and CD-RW (e.g., 195 of FIG. 1).

The CMS herein may also be delivered as part of a service engagement with a client corporation, nonprofit organization, government entity, internal organizational structure, or the like. This may include configuring a computer system to perform some or all of the methods described herein, and deploying software, hardware, and web services that implement some or all of the methods described herein. This may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

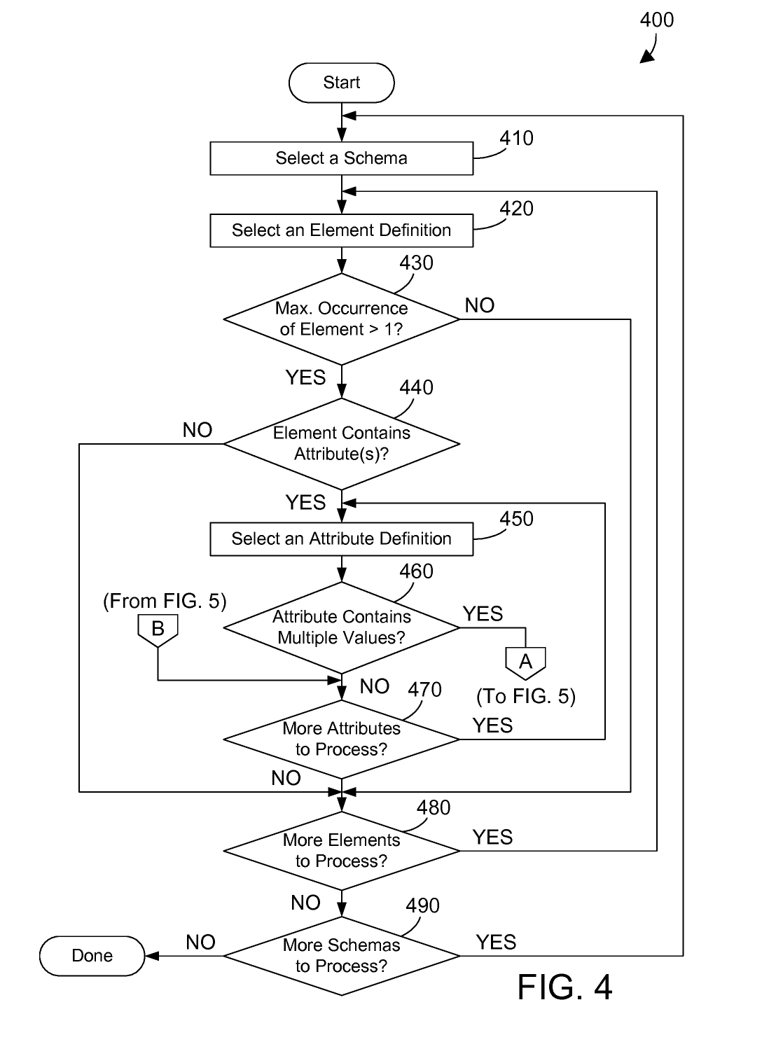

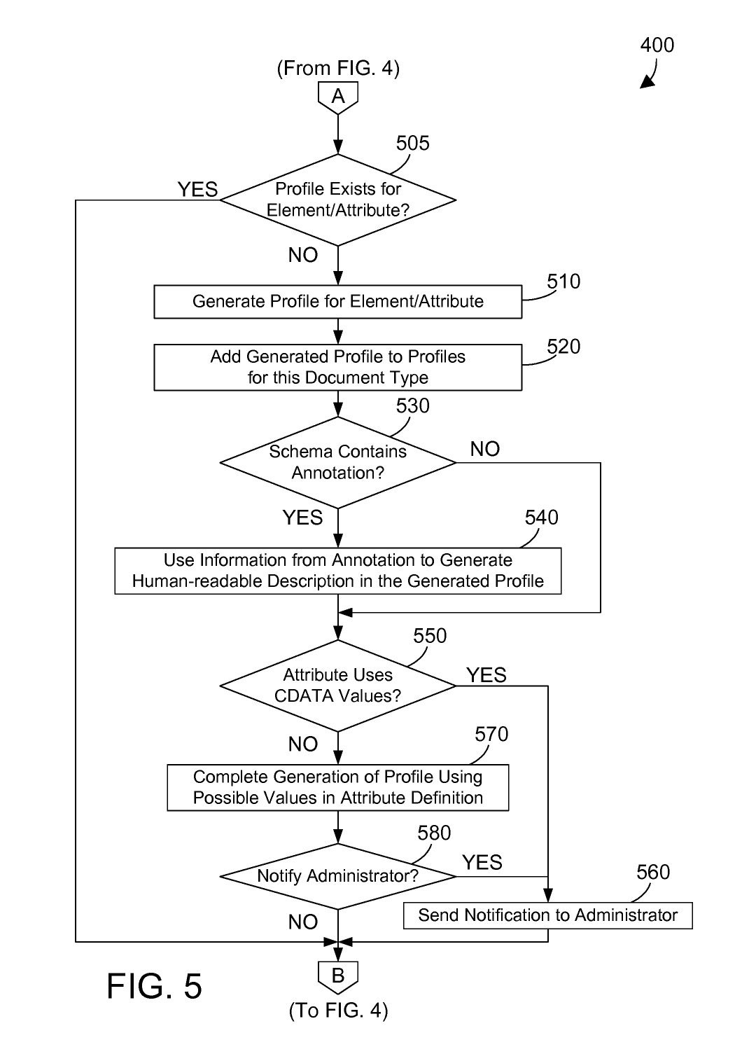

Referring to FIGS. 4 and 5, a method 400 autonomically generates a profile in a content management system. Note that method 400 could be performed at the request of a user, in response to a user modifying a schema, in response to a user creating a schema, or at a scheduled time when some or all schemas in the repository are periodically analyzed. Method 400 begins by selecting a schema to analyze (step 410). An element definition in the schema is selected (step 420). If the defined element can only occur one time (step 430=NO), method 400 goes to step 480 to determine if there are more element definitions to process. If the element may occur multiple times as defined by the schema (step 430=YES), but contains no attribute definitions (step 440=NO), method 400 goes to step 480. If the element that occurs multiple times as defined by the schema (step 430=YES) has one or more attribute definitions (step 440=YES), one of the attribute definitions is selected (step 450). If the attribute definition contains multiple possible values (step 460=YES), method 400 proceeds to marker A in FIG. 5 and continues. If the attribute definition does not contain multiple possible values (step 460=NO), method 400 determines if there are more attribute definitions for the selected element definition to process (step 470). If so (step 470=YES), method 400 loops back to step 450 and continues with the next element definition. If not (step 470=NO), method 400 determines if there are more element definitions to process (step 480). If there are more element definitions to process (step 480=YES), method 400 loops back to step 420 and continues with the next element definition. If there are no more element definitions to process (step 480=NO), method 400 determines if there are more schemas to process (step 490). If so (step 490=YES), method 400 loops back to step 410 and continues. Once there are no more schemas to process (step 490=NO), method 400 is done.

We now refer to FIG. 5 for the remainder of method 400 in FIG. 4 that begins at marker A and ends with marker B. Note the steps in FIG. 5 are performed if the pattern detection mechanism (174 in FIG. 1) detects a pattern that includes an element that occurs multiple times (step 430=YES) with one or more attributes (step 440=YES), where a selected attribute (step 450) contains multiple values (step 460=YES). If a profile already exists for the element and attribute (step 505=YES), control is passed to marker B in FIG. 4. If no profile already exists for the element and attribute (step 505=NO), a profile is autonomically generated for the element and its corresponding attribute (step 510). The newly-generated profile is then added to the profiles (e.g., 176 in FIG. 1) for this document type (step 520). Note the profile is not complete at this point because the possible values for the attribute have not been specified in the profile. If the schema contains an annotation (step 530=YES), the information from the annotation is used to generate a human-readable description of the profile in the generated profile (step 540). If the schema does not contain an annotation (step 530=NO), method 400 bypasses step 540. If the selected attribute uses CDATA values (step 550=YES), a notification is sent to an administrator (step 560). CDATA is one representation of character data that may be entered by a user. If the selected attribute uses CDATA values, the profile that is autonomically generated in step 510 and stored in step 520 is a partial profile, and the notification in step 560 tells the administrator he or she must add information to the partial profile to make it a complete profile that is ready for use in the content management system. If the attribute does not use CDATA values (step 550=NO), the generation of the profile is completed using the possible values in the attribute definition (step 570). If the administrator should be notified of the generated profile (step 580=YES), notification is sent to the administrator (step 560). Note that no action is required on the part of the administrator, the notification in step 560 following step 580=YES is to provide notification, but the profile at this point is complete in step 570 and ready for use by the content management system. At this point method 400 returns to marker B in FIG. 4 and continues.

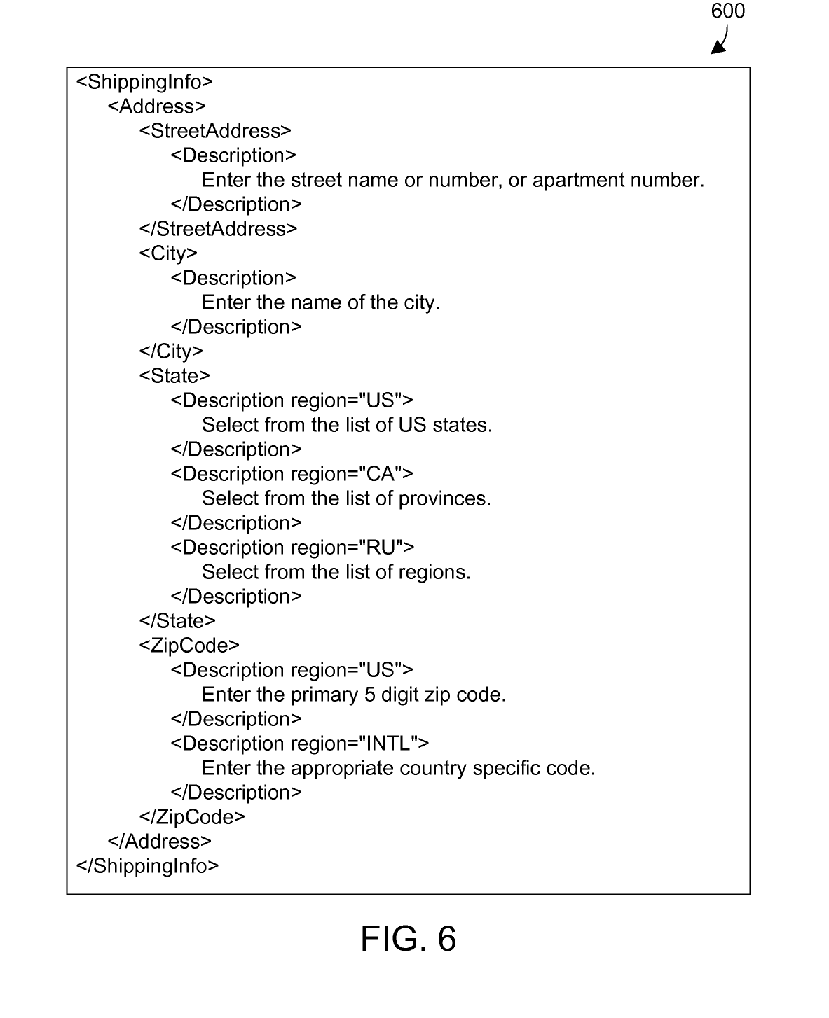

A simple example is now given to illustrate many of the concepts described above. FIG. 6 shows a sample document 600 in a content management system. Document 600 is representative of a document 154 shown in FIG. 1. We assume this document is used to prompt a user of a web site that offers goods for sale to enter a shipping address where the goods will be shipped.

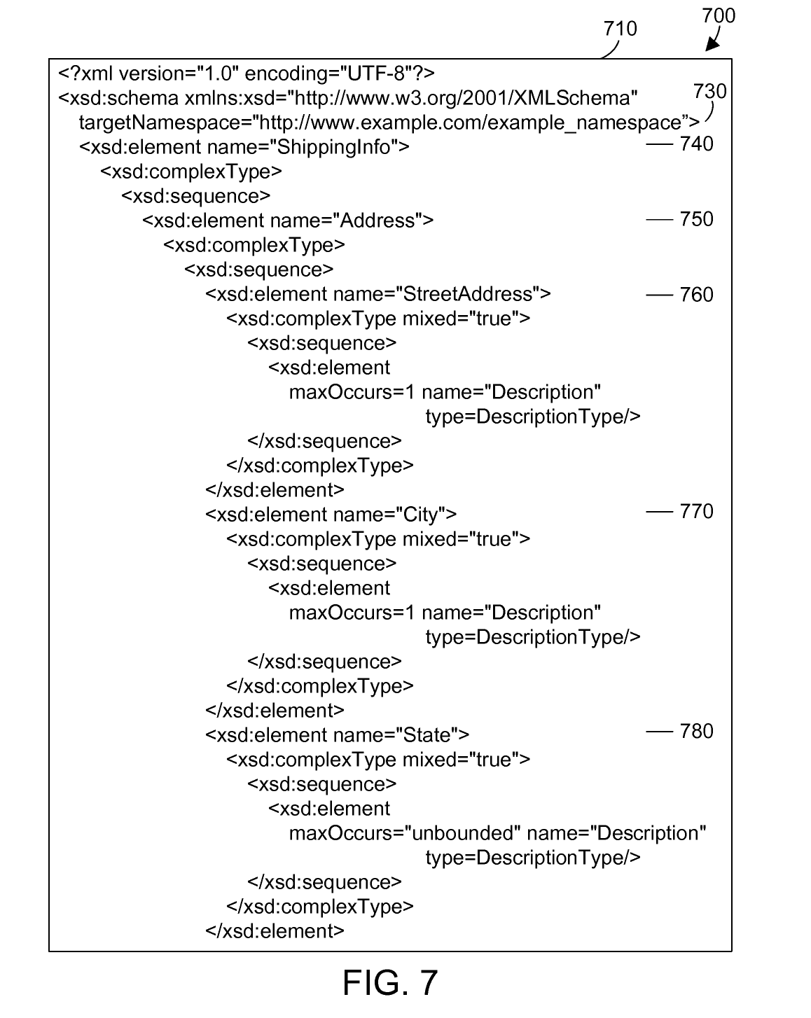

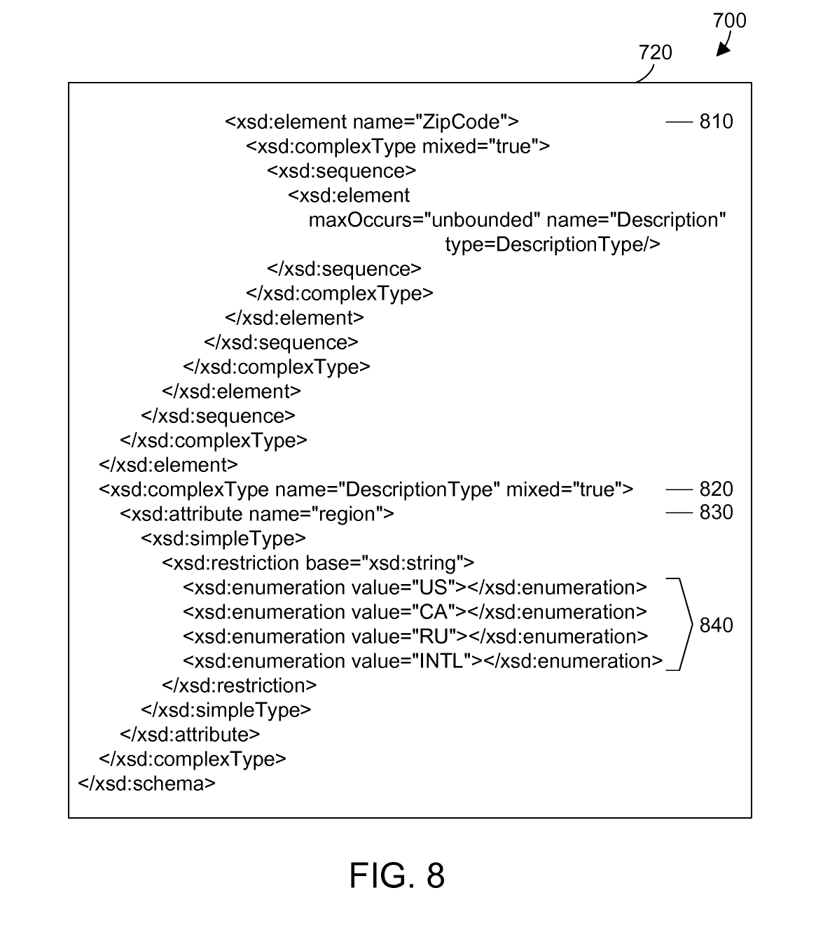

A sample schema 700 for document 600 in FIG. 6 is shown in FIGS. 7 and 8. The first part 710 of the schema 700 is shown in FIG. 7, while the second part 720 of the schema 700 is shown in FIG. 8. Note the schema 700 defines all the elements shown in document 600, including Address, StreetAddress, City, State, and ZipCode, and defines an attribute “region” at 830 that contains multiple values at 840 shown in FIG. 8. We now apply method 400 in FIGS. 4 and 5 to the schema 700 in FIGS. 7 and 8.

First, a schema is selected (step 410). We assume schema 700 in FIGS. 7 and 8 is selected. Next, an element definition in the schema is selected (step 420). The element definition for ShippingInfo at 740 is the first listed element definition in schema 700, so ShippingInfo is selected in step 420. There is no specified maximum occurrence of the ShippingInfo element, so it is assumed ShippingInfo only occurs once (step 430=NO). There are still more element definitions to process (step 480=YES), so the next element definition is selected (step 420). The next element definition in schema 700 is the Address element at 750, which is selected in step 420. Again, there is no specified maximum occurrence of the Address element, so it is assumed Address only occurs once (step 430=NO). There are still more element definitions to process (step 480=YES), so the next element definition is selected (step 420). The next element definition in schema 700 is the StreetAddress element at 760, which is selected in step 420. The StreetAddress element has an element named Description with a maxOccurs value of one, meaning the StreetAddress element includes a single Description element. As a result, the maximum occurrence of the Description element is not greater than one (step 430=NO). There are more element definitions to process (step 480=YES), so the next element is selected (step 420).

The next element definition in schema 700 is the City element at 770, which is selected in step 420. The City element has a Description element with a maxOccurs value of one, meaning the City element includes a single Description element (step 430=NO). There are more element definitions to process (step 480=YES), so the next element definition is selected (step 420). The next element definition in schema 700 is the State element at 780, which is selected in step 420. The State element has a Description element with a maxOccurs value of “unbounded”, meaning the State element may include multiple Description elements (step 430=YES). The Description element definition contains a “region” attribute definition (step 440=YES) as shown at 830 in FIG. 8. The region attribute is selected (step 450). The region attribute contains multiple possible values (step 460=YES), shown in FIG. 8 at 840.

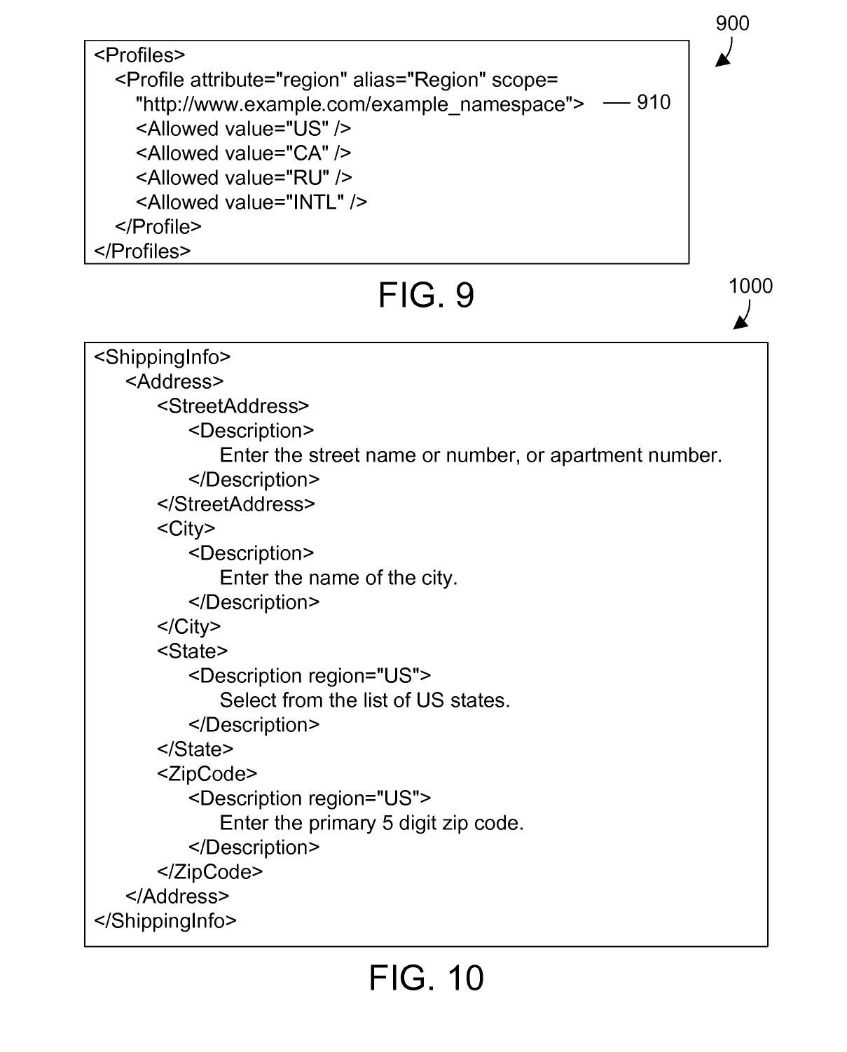

We now go to marker A in FIG. 5. We assume no profile exists for the region attribute of the Description element (step 505=NO), so a profile for the “region” attribute in the Description element is autonomically generated (step 510). The profile is generated and added to the profiles 176 shown in FIG. 1 (step 520). The schema 700 does not contain an annotation (step 530=NO), and the “region” attribute does not use CDATA values (step 550=NO), so the generation of the profile is completed using the values in the attribute definition (step 570), shown in FIG. 8 at 840. A sample profile corresponding to this “region” attribute is shown in 900 in FIG. 9. Profile 900 is scoped to the schema 700 by virtue of the scope=“http://www.example.com/example_namespace” attribute at 910 in FIG. 9, which is identical to the target namespace declaration at 730 in schema 700 in FIG. 7. Note that while not likely, it is possible for different schemas to include the same namespace declaration 730. The profile 900 in FIG. 9 is scoped to any schema that includes this namespace declaration, whether a single schema or multiple schemas.

Note the profile 900 shows four allowed values that correspond to the allowed values 840 in FIG. 8 that are specified in the schema 700. These allowed values are defined in the profile and allow the profile to filter out unwanted portions of a document when the document is rendered to a user. For example, if the profile specifies US, the portions of the document that do not match the US applicability metadata in the region attribute are not included. This is shown in FIG. 10, which shows how document 600 may be rendered to a user when the user specifies a value of US for the “region” profile. Note the portions of document 600 in FIG. 6 that correspond to CA, RU and INTL are not rendered in document 1000 in FIG. 10 because these portions of document 600 do not match the value of US for the “region” attribute in the Description element. We assume for this example the administrator need not be notified of the autonomic generation of the profile (step 580=NO), so method 400 goes to marker B in FIG. 4. There are no more attribute definitions for the Description element to process (step 470=NO), but there are more element definitions in the schema 700 to process (step 480=YES). The next element definition is the ZipCode element shown at 810 in FIG. 8, which is selected (step 420).

The ZipCode element includes a Description element with a maxOccurs value of “unbounded”, meaning the ZipCode element may include any suitable number of Description elements. This means the maximum occurrence of the Description element is greater than one (step 430=YES). The Description element contains the “region” attribute (step 440), shown in FIG. 8 at 830. The region attribute is selected (step 450). The region attribute includes multiple possible values (step 460=YES), as shown at 840 in FIG. 8. Method 400 then proceeds to marker A in FIG. 5. Because a profile already exists for the region attribute of the Description element, as shown at 900 in FIG. 9 (step 505=YES), method 400 returns to marker B in FIG. 4. There are no more attribute definitions for the Description element to process (step 470=NO), there are no more element definitions in schema 700 to process (step 480=NO), and we assume there are no more schemas to process (step 490=NO), so method 400 is done.

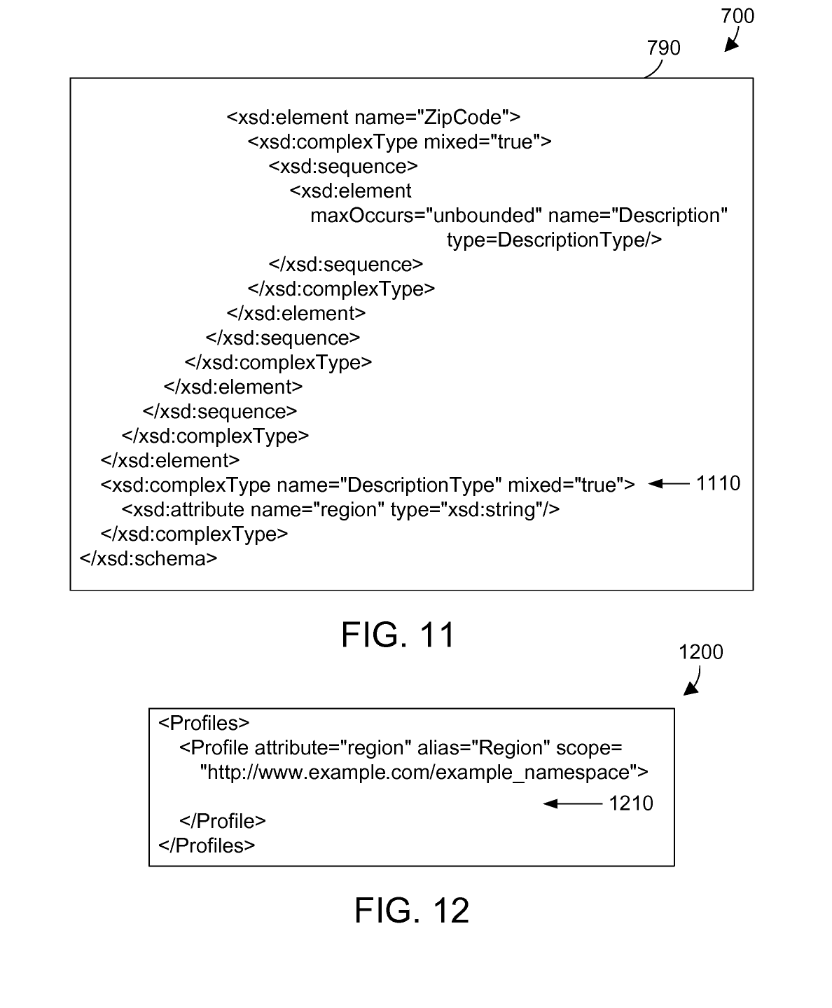

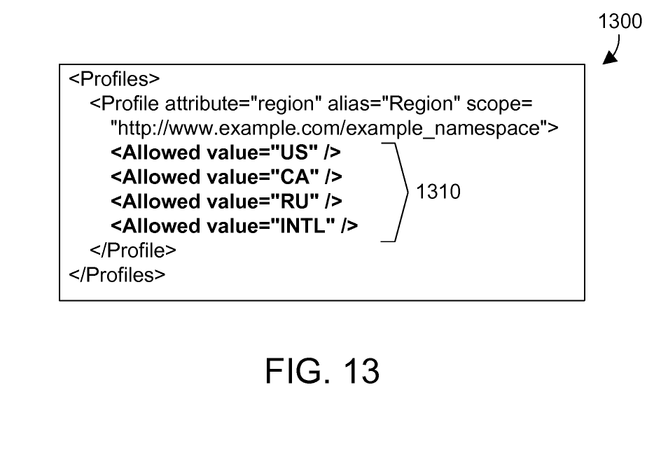

An attribute may not necessarily have multiple possible values identified in the schema for a profile to be autonomically generated. For example, if we assume the second half of schema 700 shown as 720 in FIG. 8 is replaced with 790 in FIG. 11, the attribute named “region” is defined to have a type of “string” at 1110, meaning the user can enter any suitable character data as a value for the region attribute. In this case, the autonomic profile generation mechanism does not have sufficient information to create a complete profile for the region attribute in the Description element because it cannot tell the values that may be entered by the user. As a result, a partial profile (or stub) may be generated based on the known information, as shown at 1200 in FIG. 12. Note the profile is defined, but the allowable values are not included because they cannot be determined from the schema. As a result, the portion of the profile 1200 that should define the allowable values is blank, as shown at 1210. When a partial profile is created by the autonomic profile generation mechanism, a notification is sent to an administrator to examine the partial profile and fill in the allowable values. We assume for this example the administrator edits the profile and inserts the allowable values shown in bold at 1310 in FIG. 13. Once the allowable values have been inserted by the system administrator, the profile 1300 is ready for use. Note that profile 1300 that was manually generated by an administrator manually entering the allowable values for the region attribute of the Description element is shown in these simple examples to be identical to the profile 900 in FIG. 9 that was completely generated by the autonomic profile generation mechanism. One skilled in the art will recognize these profiles could be different depending on the entries for allowable values entered by the administrator in profile 1300 in FIG. 13.

While the disclosure and figures discussed above contemplate a fully autonomous implementation, where a profile is autonomically generated and used (with or without notification to an administrator), and a partially autonomous implementation, where a partial profile is autonomically generated and provided to an administrator, who provides missing information to generate a complete profile, other implementations are possible. For example, it is within the scope of the disclosure and claims herein to autonomically generate a complete profile when there is sufficient information, but to wait in using the generated profile until an administrator reviews and approves the generated profile. This and other variations are within the scope of the disclosure and claims herein.

The autonomic profile generation mechanism disclosed and claimed herein analyzes a schema, and autonomically generates either a partial or a complete profile depending on available data in the schema. If there is sufficient information in the schema, a complete profile may be autonomically generated. If there is insufficient information in the schema, a partial profile may be autonomically generated, and an administrator is then notified to add the missing information in the partial profile to generate a completed profile. Once the generated profile is complete, it may be used by the content management system to filter out data that need not be rendered in a document according to the profile.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims. For example, while the examples in the figures and discussed above related to XML documents, the disclosure and claims herein expressly extend to content management systems that handle any suitable type of content, whether currently known or developed in the future.

What is claimed is:

1. An apparatus comprising:
at least one processor;
a memory coupled to the at least one processor;
a repository residing in the memory that includes a plurality of schemas and a plurality of documents corresponding to the plurality of schemas; and
a content management system residing in the memory and executed by the at least one processor, the content management system managing the plurality of documents in the repository, the content management system comprising:
an autonomic profile generation mechanism that analyzes a selected one of the plurality of schemas to determine whether a defined pattern exists in the selected schema, and if the defined pattern exists in the selected schema, the autonomic profile generation mechanism generates a profile for the selected schema that causes less than all elements defined in the selected schema to be rendered when a document corresponding to the selected schema is rendered to a user of the content management system.

2. The apparatus of claim 1 wherein the defined pattern comprises an element in the selected schema that may occur a plurality of times and that includes an attribute that has a plurality of possible values.

3. The apparatus of claim 1 wherein the autonomic profile generation mechanism sends notification to a system administrator regarding the generation of the profile.

4. The apparatus of claim 1 wherein the profile comprises a complete profile that may be used by the content management system.

5. The apparatus of claim 1 wherein the profile comprises a partial profile that must be added to by a human user before the profile may be used by the content management system.

6. The apparatus of claim 1 wherein if the selected schema contains an annotation, the autonomic profile generation mechanism uses information from the annotation to generate a human-readable description in the profile.

7. A computer-implemented method for autonomically generating a profile in a content management system, the method comprising the steps of:
analyzing a selected schema to determine whether a defined pattern exists in the selected schema; and
if the defined pattern exists in the selected schema, generating the profile for the selected schema that causes less than all elements defined in the selected schema to be rendered when a document corresponding to the selected schema is rendered to a user of the content management system.

8. The method of claim 7 wherein the defined pattern comprises an element in the selected schema that may occur a plurality of times and that includes an attribute that has a plurality of possible values.

9. The method of claim 7 wherein the autonomic profile generation mechanism sends notification to a system administrator regarding the generation of the profile.

10. The method of claim 7 wherein the profile comprises a complete profile that may be used by the content management system.

11. The method of claim 7 wherein the profile comprises a partial profile that must be added to by a human user before the profile may be used by the content management system.

12. The method of claim 7 further comprising the step of:
if the selected schema contains an annotation, using information from the annotation to generate a human-readable description in the profile.

13. A computer-implemented method for autonomically generating a profile in a content management system, the method comprising the steps of:
analyzing a selected schema to determine whether an element in the selected schema may occur a plurality of times and includes an attribute that has a plurality of possible values;
if an element in the selected schema may occur a plurality of times and includes an attribute that has a plurality of possible values, generating a partial profile for the selected schema;
notifying a human user of the partial profile;
if the selected schema contains an annotation, using information from the annotation to generate a human-readable description in the partial profile;
receiving information from the human user to generate from the partial profile a complete profile; and
using the complete profile to render less than all elements defined in the selected schema when a document corresponding to the selected schema is rendered to a user of the content management system.

14. An article of manufacture comprising:
(A) a content management system comprising:
an autonomic profile generation mechanism that analyzes a selected one of a plurality of schemas to determine whether a defined pattern exists in the selected schema, and if the defined pattern exists in the selected schema, the autonomic profile generation mechanism generates a profile for the selected schema that causes less than all elements defined in the selected schema to be rendered when a document corresponding to the selected schema is rendered to a user of the content management system; and
(B) computer-readable media bearing the content management system.

15. The article of manufacture of claim 14 wherein the defined pattern comprises an element in the selected schema that may occur a plurality of times and that includes an attribute that has a plurality of possible values.

16. The article of manufacture of claim 14 wherein the autonomic profile generation mechanism sends notification to a system administrator regarding the generation of the profile.

17. The article of manufacture of claim 14 wherein the profile comprises a complete profile that may be used by the content management system.

18. The article of manufacture of claim 14 wherein the profile comprises a partial profile that must be added to by a human user before the profile may be used by the content management system.

19. The article of manufacture of claim 14 wherein if the selected schema contains an annotation, the autonomic profile generation mechanism uses information from the annotation to generate a human-readable description in the profile.
